(19) United States
(12) Patent Application Publication
(10) Pub. No.: US 2024/0237665 A1
(43) Pub. Date: Jul. 18, 2024

(54) METHOD FOR PRODUCTION OF HAZELNUT MILK

(71) Applicant: BALSU GIDA SANAYI VE TICARET ANONIM SIRKETI, Sakarya (TR)

(72) Inventor: Emel OZENGEN, Sakarya (TR)

(73) Assignee: BALSU GIDA SANAYI VE TICARET ANONIM SIRKETI, Sakarya (TR)

(21) Appl. No.: 18/290,787

(22) PCT Filed: Jul. 20, 2022
(86) PCT No.: PCT/TR2022/050773

§ 371 Date: Jan. 21, 2024

(30) Foreign Application Priority Data
Sep. 10, 2021 (TR) 2021/014223

(51) Int. Cl. A23C 11/10; A23L 25/00

(52) U.S. Cl. CPC A23C 11/103; A23L 25/30

(57) ABSTRACT

A method for the production of hazelnut milk is provided. Hazelnut milk with high purity and low cost was obtained with the method. The method includes the following steps: a. supplying hazelnuts; b. subjecting hazelnuts to the shelling process; c. adding water to the shelled hazelnuts; d. keeping the hazelnuts to which water is added for 24 hours; e. weighing of wet hazelnuts obtained in step d; f. taking the weighted wet hazelnuts into the mixer; g. adding water to the hazelnuts taken into the mixer in step f; h. mixing the hazelnuts to which water is added in step g in the mixer; i. filtering the mixture obtained in step h; j. subjecting the milk obtained in step i to heat treatment.

### CROSS-REFERENCE TO THE RELATED APPLICATIONS

This application is the national phase entry of International Application No. PCT/TR2022/050773, filed on Jul. 20, 2022, which is based upon and claims priority to Turkish Patent Application No. 2021/014223, filed on Sep. 10, 2021, the entire contents of which are incorporated herein by reference.

### TECHNICAL FIELD

The invention provides a method for the production of hazelnut milk. Hazelnut milk with high purity and low cost was obtained with the method of the invention.

### BACKGROUND

Hazelnut contains phosphorus, potassium, calcium, zinc, iron and magnesium. These minerals are extremely necessary for forming tissues and continuing vital functions in the body. It is vital for the metabolic functions in cells to continue to function.

Since omega-9 fatty acids found in hazelnuts are also found in milk, they are very effective in protecting against cardiovascular diseases. Hazelnut milk also contains a small amount of omega-3 fatty acids. The omega-3 fatty acid is one of the important fatty acids for brain and eye health.

Thanks to folic acid as well as B group vitamins such as B1, B2, B3, and B6 in hazelnut content, hazelnut milk consumption enables the nervous system to work. It lowers bad cholesterol, increases good cholesterol, and lowers triglycerides. Studies have shown that regular consumption of hazelnut milk prevents heart diseases to a great extent.

Vitamin E, magnesium and zinc, which are found in hazelnut milk, prevent cell destruction because they have antioxidant properties. This allows ageing to be delayed. Since it contains fiber, it relaxes the digestive system and prevents constipation.

Due to all these benefits, hazelnut milk production is of great interest today and various studies are carried out to develop alternative processes in the state of the art.

Patent application numbered TR201603611 relates to a method for producing hazelnut milk without using additives. Patent application numbered TR201620269 deals with fermented hazelnut milk products with probiotic properties. The patent application numbered CN104222282 is also related to a technology used in the preparation of hazelnut milk and hazelnut milk.

The main object of the present invention is to provide a method for obtaining high-purity, low-cost hazelnut milk, unlike the hazelnut milk preparation processes of the art.

### SUMMARY

The main object of the invention relates to a method for the production of hazelnut milk, comprising the steps of:
a. Supplying hazelnuts,
b. subjecting hazelnuts to the shelling process,
c. adding water to the shelled hazelnuts,
d. keeping the hazelnuts on which water is added for 24 hours,
e. weighing of wet hazelnuts obtained in step d,
f. taking the weighted wet hazelnuts into the mixer,
g. adding water to the hazelnuts taken into the mixer in step f,
h. mixing the hazelnuts to which water is added in step g in the mixer,
i. filtering the mixture obtained in step h,
j. subjecting the milk obtained in step i to heat treatment.

The hazelnuts in the method of the invention are selected from a list consisting of raw hazelnuts, roasted hazelnuts, whitened hazelnuts or a mixture thereof. The production method of the present invention preferably comprises raw hazelnuts.

In an embodiment of the invention, in step b of the method of the invention, the hazelnuts are cleared of bad and rotten ones. The shelled hazelnuts are then taken into a large container.

In one embodiment of the invention, in step c of the method of the invention, water is added up to the surface level of the hazelnut in the container.

In one embodiment of the invention, the hazelnuts to which water is added are kept at a temperature of 5-15° C. and preferably 10° C. for 24 hours in step d. Wet hazelnuts obtained in step d are weighted and taken to the mixer.

In one embodiment of the invention, 200 mL of water is added for every 100 grams of hazelnuts in step g on the hazelnuts whose amount by weight is determined in step e of the method of the invention. In this embodiment of the invention, the mixture obtained in step g is mixed for 3-10 minutes and preferably 5 minutes in step h.

In one embodiment of the invention, the filtration process in step i of the method of the invention is carried out with cotton woven fabric. The cotton woven fabric's pore size is 50 microns, 40 microns, or preferably less than 30 microns. Pulp and milk resulting from the filtration process are weighted.

In one embodiment of the invention, the milk obtained in step i of the method of the invention is subjected to heat treatment at 70-95° C. and preferably 80-85° C. for 8-10 minutes in step j.

### DETAILED DESCRIPTION OF THE EMBODIMENTS

The main object of the invention relates to a method for the production of hazelnut milk, comprising the steps of:
a. Supplying hazelnuts,
b. subjecting hazelnuts to the shelling process,
c. adding water to the shelled hazelnuts,
d. keeping the hazelnuts on which water is added for 24 hours,
e. weighing of wet hazelnuts obtained in step d,
f. taking the weighted wet hazelnuts into the mixer,
g. adding water to the hazelnuts taken into the mixer in step f,
h. mixing the hazelnuts to which water is added in step g in the mixer,
i. filtering the mixture obtained in step h,
j. subjecting the milk obtained in step i to heat treatment.

The purity of the product and the cost of the production method are the most important criteria in hazelnut milk production. The fewer chemical products used during production and the less heat applied, the healthier and purer the resulting product. Therefore, it becomes more preferred by the consumer. The main embodiment of the present invention is to present a cost-effective method for the production of high purity hazelnut milk. Since the method can be carried out by using simple tools known in the art, its cost becomes quite low.

The hazelnuts in the method of the invention are selected from a list consisting of raw hazelnuts, roasted hazelnuts, whitened hazelnuts or a mixture thereof. The production method of the present invention preferably comprises raw hazelnuts.

In an embodiment of the invention, in step b of the method of the invention, the hazelnuts are cleared of rotten and bad ones. The shelled hazelnuts are then taken into a large container.

In one embodiment of the invention, in step c of the method of the invention, water is added up to the surface level of the hazelnut in the container. The amount of said water is twice as much as the amount of hazelnut obtained in step b.

In one embodiment of the invention, the hazelnuts to which water is added are kept at a temperature of 5-15° C. and preferably 10° ° C. for 24 hours in step d. Wet hazelnuts obtained in step d are weighted and taken to the mixer. Thus, since hazelnuts do not undergo any heat treatment while they are natural, they can be brined without deteriorating or oxidizing the fat structure.

In one embodiment of the invention, 200 mL of water is added for every 100 grams of hazelnuts in step g on the hazelnuts whose amount by weight is determined in step e of the method of the invention. In this embodiment of the invention, the mixture obtained in step g is mixed for 3-10 minutes and preferably 5 minutes in step h.

In one embodiment of the invention, the filtration process in step i of the method of the invention is carried out with cotton woven fabric. The cotton woven fabric's pore size is 50 microns, 40 microns, or preferably less than 30 microns. Pulp and milk resulting from the filtration process are weighted. As a result, hazelnut milk preserves its natural milk color.

In one embodiment of the invention, the milk obtained in step i of the method of the invention is subjected to heat treatment at 70-95° ° C. and preferably 80-85° C. for 8-10 minutes in step j. Hazelnut milk, which can be preserved for a long time without using any preservative or sweetening agent, without deteriorating its purity, taste, smell and color, is obtained by this pasteurization process of the invention applied to milk.

### Example—Production of Hazelnut Milk

Some raw hazelnuts are separated from rotten and bad ones. 250 g of shelled raw hazelnuts are taken into a large container. Water (500 mL) is added until it passes over the hazelnuts. It is kept in a cool or cold (preferably 10° C.) environment for 24 hours. Wet hazelnuts are weighted. 200 grams of wet hazelnuts are taken into the mixer. 400 mL of water is added to it. It is mixed with the mixer for 5 minutes. The mixture is filtered through a diaper. The resulting pulp and milk are weighted. It is subjected to heat treatment at 80-85° C. for 8-10 minutes in the resulting milk stirrer heater. It is kept at +4° C. in 1 L glass jars.

The scope of the protection of the invention is set forth in the annexed claims and certainly cannot be limited to exemplary explanations in this detailed description. It is evident that one skilled in the art can make similar embodiments in the light of the explanations above without moving away the main theme of the invention.

What is claimed is:

1. A method for production of hazelnut milk, comprising the following steps:
a. supplying hazelnuts,
b. subjecting the hazelnuts to shelling process to obtain shelled hazelnuts,
c. adding water to the shelled hazelnuts,
d. keeping the shelled hazelnuts where water is added for 24 hours, wherein the shelled hazelnuts are kept at a temperature of 5-15° C. or 10° ° C. to obtain wet hazelnuts,
e. weighing of the wet hazelnuts obtained in step d,
f. taking the weighted wet hazelnuts into mixer,
g. adding water to the weighted wet hazelnuts taken into the mixer in step f,
h. mixing the hazelnuts where water is added in step g in the mixer to obtain a mixture,
i. filtering the mixture obtained in step h to obtain milk, wherein cotton woven fabric has a pore size of less than 30 microns,
j. subjecting the milk obtained in step i to heat treatment.

2. (canceled)

3. The method according to claim 1, wherein an amount of the hazelnuts is determined by weight in step e and 200 ml of water is added for every 100 grams of the hazelnut in step g.

4. The method according to claim 1, wherein the mixing process in step h takes 3-10 minutes or 5 minutes.

5. The method according to claim 1, wherein the filtration process in step i is carried out with the cotton woven fabric.

6. (canceled)

7. The method according to claim 1, wherein the heat treatment in step j is carried out at 70-95° C. or 80-85° C.

8. The method according to claim 1, wherein the heat treatment in step j is maintained for 8-10 minutes.

9. The method according to claim 3, wherein the mixing process in step h takes 3-10 minutes or 5 minutes.

10. The method according to claim 3, wherein the heat treatment in step j is carried out at 70-95° ° C. or 80-85° C.

11. The method according to claim 4, wherein the heat treatment in step j is carried out at 70-95° C. or 80-85° C.

12. The method according to claim 5, wherein the heat treatment in step j is carried out at 70-95° C. or 80-85° C.

13. The method according to claim 3, wherein the heat treatment in step j is maintained for 8-10 minutes.

14. The method according to claim 4, wherein the heat treatment in step j is maintained for 8-10 minutes.

15. The method according to claim 5, wherein the heat treatment in step j is maintained for 8-10 minutes.

16. The method according to claim 7, wherein the heat treatment in step j is maintained for 8-10 minutes.
